(19) United States
(12) Patent Application Publication
(10) Pub. No.: US 2026/0335793 A1
(43) Pub. Date: Oct. 29, 2026

(54) FUEL FILTER WITH SLOTTED ENDCAP

(71) Applicant: PGI NORTHSTAR LLC, Memphis, TN (US)

(72) Inventors: Sandeep BELLARALLI SWAMY, Somvarapete (IN); Anil KUMAR H C, Karnataka (IN); Todd KRZYCKI, Cincinnati, OH (US)

(73) Assignee: PGI NORTHSTAR LLC, Memphis, TN (US)

(21) Appl. No.: 19/658,281

(22) Filed: Apr. 24, 2026

(30) Foreign Application Priority Data
Apr. 25, 2025 (IN) 202511040050

(51) Int. Cl. B01D 29/31; B01D 35/30; B01D 36/00

(52) U.S. Cl. CPC B01D 29/31; B01D 35/30; B01D 36/003; B01D 2201/12; B01D 2201/291; B01D 2201/301; B01D 2201/4046

(57) ABSTRACT

A fuel filter assembly designed for simplified and intuitive installation into a housing, ensuring proper alignment. The fuel filter assembly includes a plastic endcap, a water separator, an integrated center tube, a coalescer, a pleated pack, and a metallic endcap. The plastic endcap features alignment aids, such as a notch or channel on its perimeter, which aligns with a corresponding protrusion in the housing to ensure proper installation. The pleated pack is designed to accommodate the notch without affecting performance, with reduced pleat height in the areas where the notch is located to prevent pleat deformation, which could lead to higher differential pressure and lower dust loading capacity.

### TECHNICAL FIELD

The present disclosure relates to fluid filters, and more particularly to fuel filters for motor vehicles.

### BACKGROUND ART

Fuel filters can be used to filter a variety of different fluids are produced in many configurations. One type of fuel filter includes a filter element that fits into filter housing. This type of filter is in the form of a replace able cylindrical shaped pleated element that can be removed and replaced from the filter housing. The filter element ensures that particulate matter and other impurities are removed from fuel before it is delivered to the fuel injection system. The filter housing is typically permanently attached to the vehicle.

In order to ensure proper functionality of the fuel filter it is necessary to ensure it is installed correctly and securely to the housing. A number of issues can arise while installing a fuel filter, which can make installation difficult. For example, a fuel filter can be misaligned affecting performance or become stuck in the housing if installed incorrectly. In such cases of improper installation, there may be spillage as a result. It may take additional time to reinstall or even replace the filter, increasing the labor cost of installing the fuel filter.

### SUMMARY OF THE INVENTION

The present disclosure addresses these and other issues by providing a fuel filter assembly with features that make it simple and intuitive to properly install into a housing. A fuel filter assembly can include a plastic endcap, a water separator, an integrated center tube, a coalescer, a pleated pack, and a metallic endcap.

A plastic endcap can have features that aid in alignment when installing the fuel filter assembly into a housing. Such features can include a slot, notch, channel or the like on the perimeter of the end cap that can only be installed when aligned with a matching feature in the housing. This feature can be a protrusion that extends into the notch when the fuel filter and housing are aligned properly.

The fuel filter assembly can be designed so that the notch does not disturb the distribution of the pleated pack that surrounds the fuel filter assembly, so performance is not affected. Pleat deformation causes a higher differential pressure and can result in lower dust loading capacity. The pleats of the pleated pack in the fuel filter assembly are designed to lay around the notch. This can be accomplished by having one or more pleat that has a reduced height at the location where the notch lays. Other features can include eccentric protrusions along the inner circumference of an orifice in the center of the endcap.

In one aspect, an exemplary embodiment of the present disclosure may provide fuel filter assembly as described herein.

In another aspect, an exemplary embodiment of the present disclosure may provide a method of use for a fuel filter assembly as described herein.

### BRIEF DESCRIPTION OF THE DRAWINGS

Sample embodiments of the present disclosure are set forth in the following description, are shown in the drawings and are particularly and distinctly pointed out and set forth in the appended claims.

FIG. 1 is a front elevation view of a fuel filter assembly according to one aspect of the present disclosure.

FIG. 2 is an exploded view of a fuel filter assembly according to one aspect of the present disclosure.

FIG. 3A is a top side view of an endcap according to one aspect of the present disclosure.

FIG. 3B is a side view of an endcap according to one aspect of the present disclosure.

FIG. 3C is a bottom view of an endcap according to one aspect of the present disclosure.

FIG. 4 is a cutaway view of a fuel filter assembly installed in a housing according to one aspect of the present disclosure.

FIG. 5A is a top side view of a pleated wrap according to one aspect of the present disclosure.

FIG. 5B is a top side view of a fuel filter assembly according to one aspect of the present disclosure.

FIG. 5C is a front perspective view of a pleated wrap assembly according to one aspect of the present disclosure.

FIG. 6A is a side view of an endcap according to one aspect of the present disclosure.

FIG. 6B is a top side view of an endcap according to one aspect of the present disclosure.

FIG. 7 is a front elevation view of a fuel filter assembly according to one aspect of the present disclosure.

FIG. 8A is a top side of an endcap according to one aspect of the present disclosure.

FIG. 8B is a top perspective view of an endcap according to one aspect of the present disclosure.

FIG. 9 is a side view of a water separator according to one aspect of the present disclosure.

FIG. 10 is a side view of an integrated center tube with a water separator according to one aspect of the present disclosure.

FIG. 11 is a front elevation view of a fuel filter assembly according to another aspect of the present disclosure.

FIG. 12 is a front view of a fuel filter assembly according to still another aspect of the present disclosure

Similar numbers refer to similar parts throughout the drawings.

### DETAILED DESCRIPTION

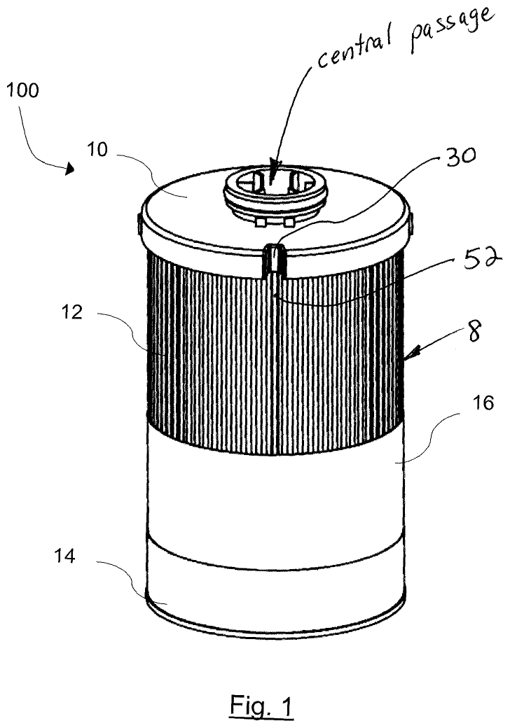

Referring in more detail to the drawings, FIG. 1 illustrates front elevation view of an exemplary embodiment of a fuel filter assembly 100. A fuel filter assembly 100, as described in detail below, can have features that make it simple and intuitive to properly install a filter element 8 into a housing 42 (as seen in FIG. 4). The fuel filter element 8 has an endcap 10 forming a slot 30. The endcap 10 attached to a housing 42. A pleated wrap 12 depends from the distal endcap 10. An optional proximal metal endcap 14 and half wrap 16 surround a portion of the pleated wrap 8.

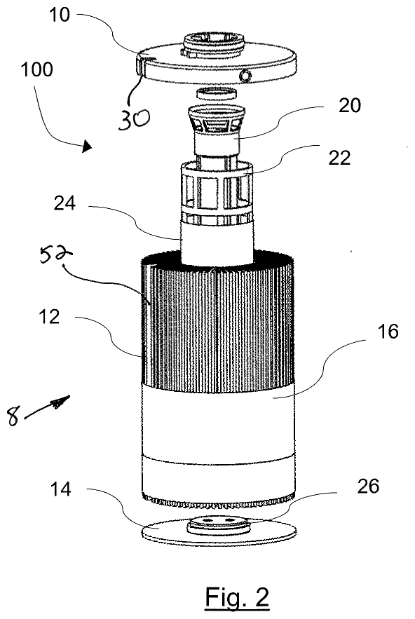

FIG. 2 illustrates an exploded view of a fuel filter assembly 100. Fuel filters can include an endcap 10, a pleated wrap 12, and a metal endcap 14, a water separator 20, a center tube 22, a coalescer 24, and a relief valve assembly 26. A water separator 20 can be placed in a center tube 22 in the central portion of the fuel filter assembly 100. FIG. 2 is just one non-limiting example of how a fuel filter 100 is assembled. Fuel filters assemblies 100 can be in a variety of desirable configurations and achieve the same result.

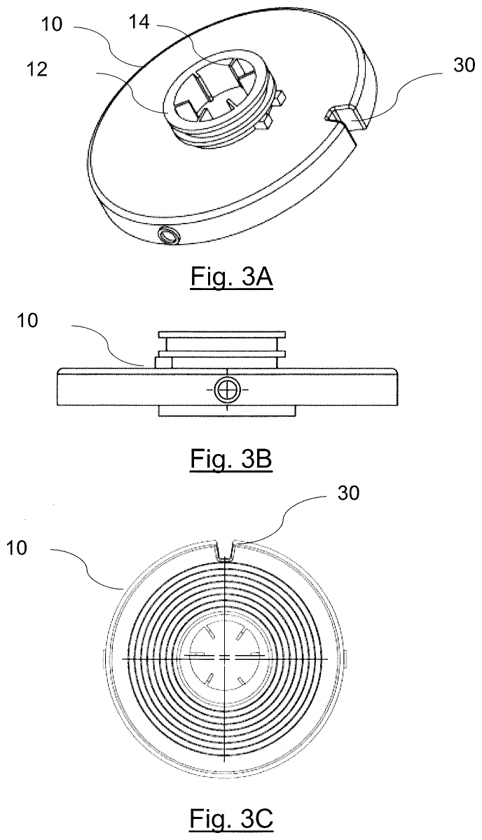

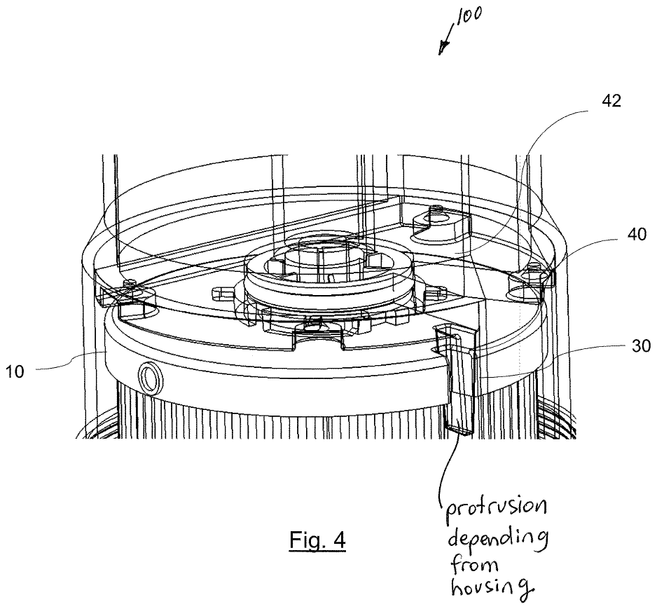

FIGS. 3A-3C illustrate a notched endcap 10 that a fuel filter assembly 100 can have. An endcap 10 can be made of a variety of materials including plastic. An endcap 10 can have features that aid in alignment when installing the fuel filter assembly 100 into a housing 42. A slot or notch 30 can be formed at the perimeter of an endcap 10 to aid in alignment with a housing 42. A notch 30 in the endcap 10 can also provide an added barrier for adhesive containment to aid in preventing an adhesive from overflowing which may prevent proper mating with a housing 42. A notch 30 can be any desirable geometry to achieve similar results. An endcap 10 can have eccentric protrusions 14 along the inner circumference of an orifice in the center 12 of the endcap. These protrusions 14 can aid in securing and aligning a center tube 22 or a water separator 20 when the fuel filter assembly 100 is assembled.

FIG. 4 is a cutaway view of a fuel filter assembly 100 installed in a housing 42. A housing 42 can have a protrusion 40 that extends into the notch 30 when the fuel filter 100 and housing 42 are aligned properly. Proper alignment of the fuel filter 100 and the housing 42 will aid in preventing leakage and in the performance of the fuel filter 100.

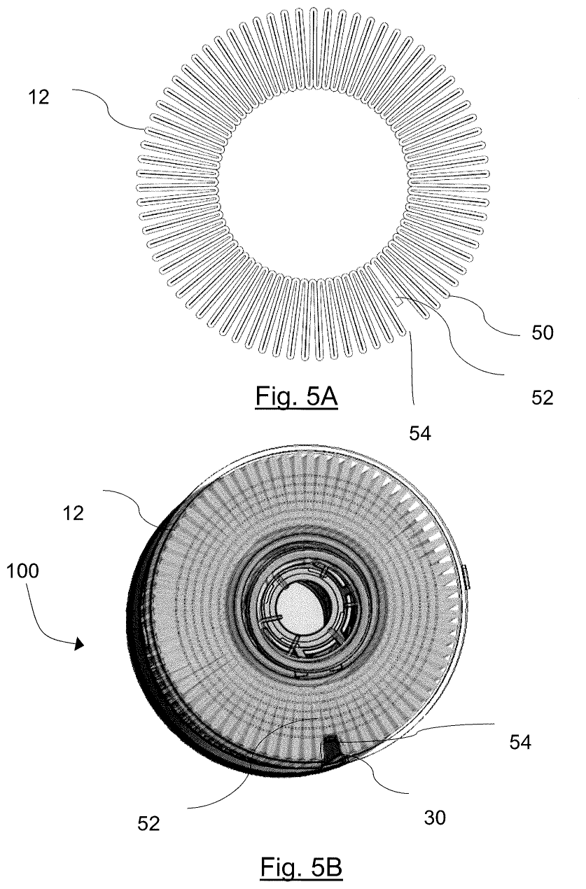

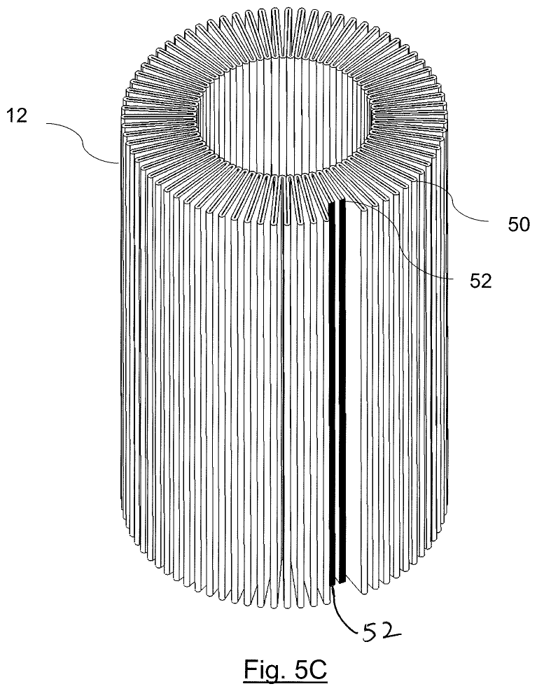

FIG. 5A is a top side view of a pleated wrap 12. A pleated wrap can have pleats 50 of a mostly uniform length. A fuel filter assembly 100 can be designed so that the notch 30 does not disturb the distribution of the pleated pack 12 that surrounds the fuel filter assembly 100, so performance is not affected. Pleat 50 deformation can cause a higher differential pressure and can result in lower dust loading capacity. In order to prevent this, one or more pleat 52 in the pleated wrap 12 can have a reduced height at the location 54 where the notch 30 lays. This is illustrated in FIG. 5B where you can see the location of the notch 30 is aligned with the pleat of a reduced height 52. FIGS. 5A-5B show that one pleat has a reduced height 54 for illustrative purposes, however any desirable number of pleats 50 can be reduced to accommodate the space 54 needed for the notch 30. For example, in FIG. 5B, two pleats 52 are of a smaller radius. A pleated wrap 12 can be joined by any desirable method including ultrasonic welding.

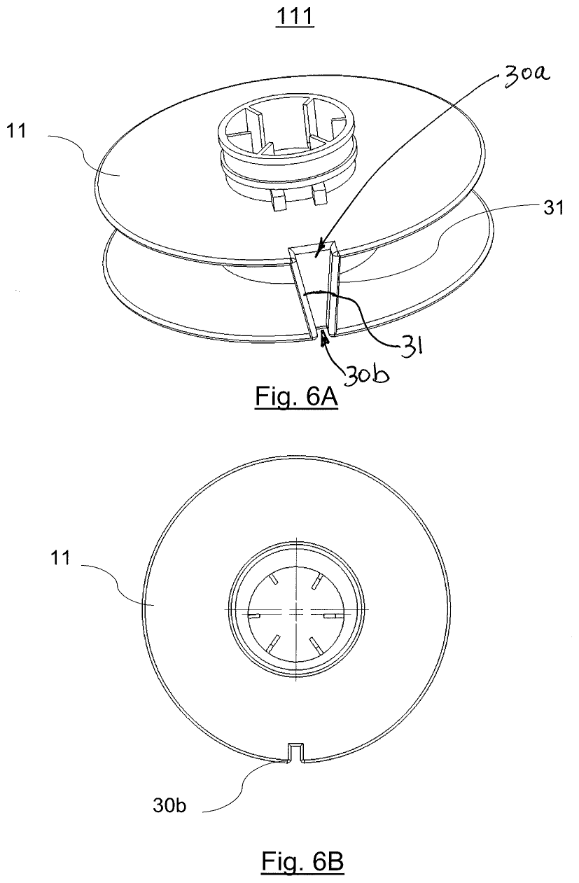

FIG. 6A is a side perspective view and FIG. 6B is a bottom view an endcap with a double disc construction 11. An endcap 11 can be constructed for a variety of desirable ways to achieve a similar result. In this non-limiting example, an endcap 11 can be of a double disk construction, with a notch 30a, 30b aligned on each disc and sidewalls 31 extending between the notches 30a, 30b. As can be seen, the sidewalls 31 are angled to act as a guide for easier insertion.

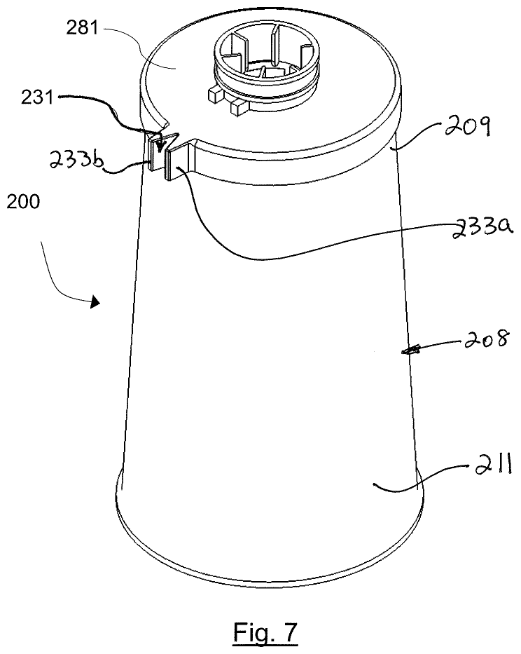

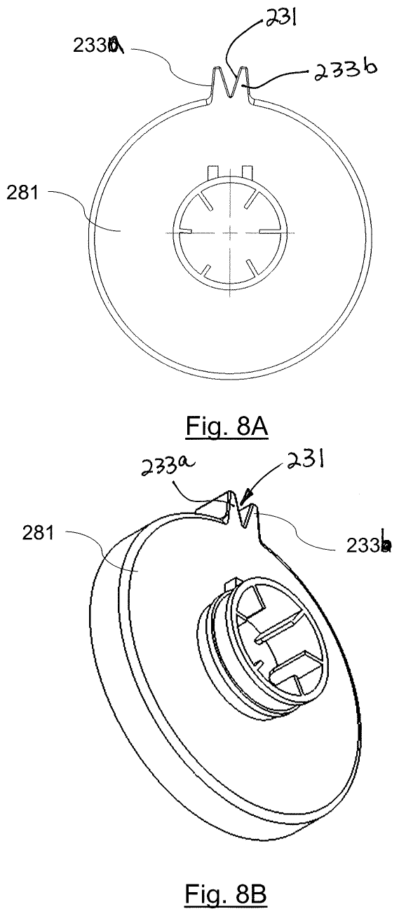

FIG. 7 is a front elevation view of another fuel filter assembly 200. The fuel filter assembly 200 can also be made in a conical design and the endcap 281 can have a pair of opposing protrusions 233a, 233b. The protrusions 233a, 233b form a v-shaped notch 231 but the slot, notch or channel can be constructed in any desirable shape such as a U-shape, C-shape, square shape, trapezoidal shape and the like. FIGS. 8A and 8B are different views of the endcap 281, which show a protruding v-shaped notch 31. The location of the notch 231 in combination of the shape of the fuel filter assembly 200 ensure that the pleats of the wrap are not deformed. As best seen in FIG. 7, the filter element 208 has at least a portion of the distal end 209 with a relatively narrower circumference than the proximal end or base 211 of the filter element 208.

Thus, a protrusion that depends down can pass through the notch 231 without interfering with the filter element whether the filter element is pleated or otherwise constructed.

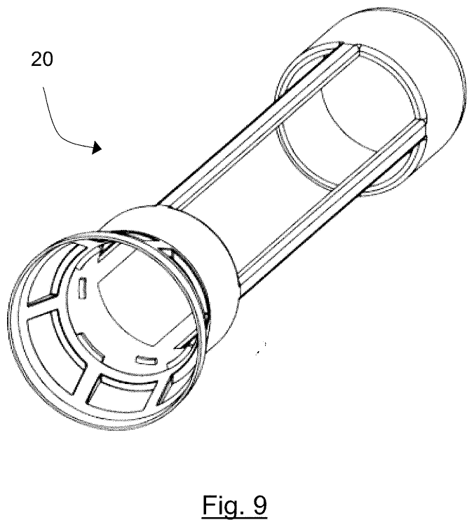

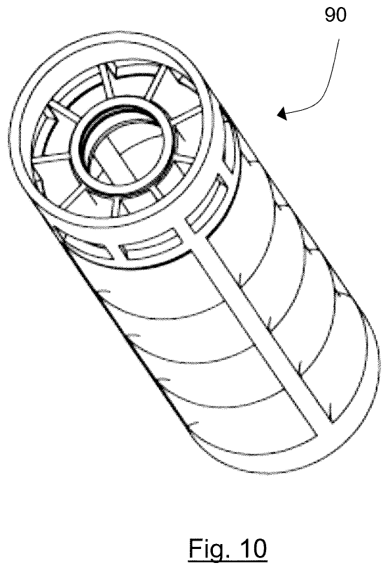

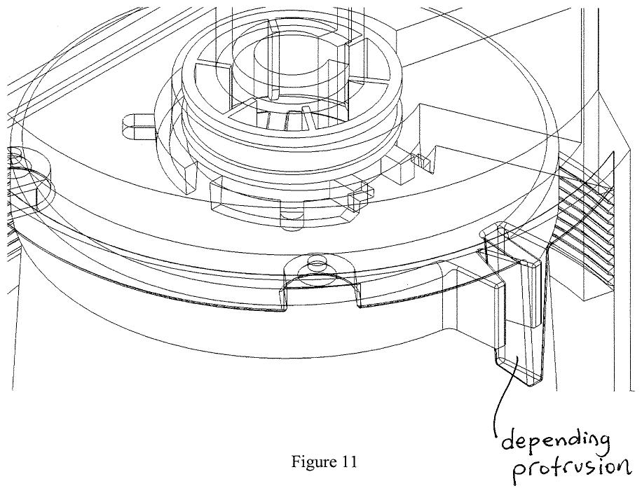

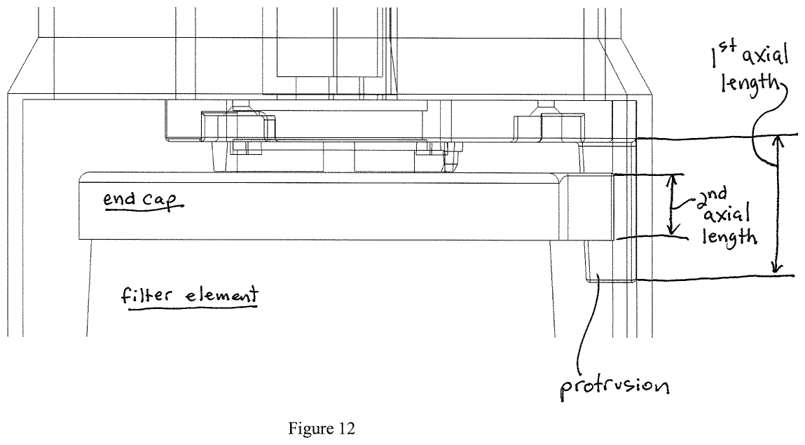

FIG. 9 is a side view of a water separator 20 of a fuel assembly filter 100. A water separator is inserted into a center tube 22 in the middle of a fuel filter assembly 100. A hydrophobic mesh (not shown) can be placed around a water separator 20. A fuel filter assembly can also include an integrated center tube 90, as seen in FIG. 10 instead of a separate water separator 20 and center tube 22. A center tube 22 or integrated center tube 90 can permits fuel to pass through and separates water from fuel in the process. A water separator 20 or integrated center tube 90 can have a hydrophobic mesh (not shown) to help separate water from fuel.

Various inventive concepts may be embodied as one or more methods, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

While various inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

All definitions, as defined and used herein, should be understood to control over dictionary definitions, definitions in documents incorporated by reference, and/or ordinary meanings of the defined terms.

The articles “a” and “an,” as used herein in the specification and in the claims, unless clearly indicated to the contrary, should be understood to mean “at least one.” The phrase “and/or,” as used herein in the specification and in the claims (if at all), should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc. As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

While components of the present disclosure are described herein in relation to each other, it is possible for one of the components disclosed herein to include inventive subject matter, if claimed alone or used alone. In keeping with the above example, if the disclosed embodiments teach the features of A and B, then there may be inventive subject matter in the combination of A and B, A alone, or B alone, unless otherwise stated herein.

When a feature or element is herein referred to as being “on” another feature or element, it can be directly on the other feature or element or intervening features and/or elements may also be present. In contrast, when a feature or element is referred to as being “directly on” another feature or element, there are no intervening features or elements present. It will also be understood that, when a feature or element is referred to as being “connected”, “attached” or “coupled” to another feature or element, it can be directly connected, attached or coupled to the other feature or element intervening features or elements may be present. In contrast, when a feature or element is referred to as being “directly connected”, “directly attached” or “directly coupled” to another feature or element, there are no intervening features or elements present. Although described or shown with respect to one embodiment, the features and elements so described or shown can apply to other embodiments. It will also be appreciated by those of skill in the art that references to a structure or feature that is disposed “adjacent” another feature may have portions that overlap or underlie the adjacent feature.

Spatially relative terms, such as “under”, “below”, “lower”, “over”, “upper”, “above”, “behind”, “in front of”, and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if a device in the figures is inverted, elements described as “under” or “beneath” other elements or features would then be oriented “over” the other elements or features. Thus, the exemplary term “under” can encompass both an orientation of over and under. The device may be otherwise oriented (rotated 90 degrees or at other orientations) and the spatially relative descriptors used herein interpreted accordingly. Similarly, the terms “upwardly”, “downwardly”, “vertical”, “horizontal”, “lateral”, “transverse”, “longitudinal”, and the like are used herein for the purpose of explanation only unless specifically indicated otherwise.

Although the terms “first” and “second” may be used herein to describe various features/elements, these features/elements should not be limited by these terms, unless the context indicates otherwise. These terms may be used to distinguish one feature/element from another feature/element. Thus, a first feature/element discussed herein could be termed a second feature/element, and similarly, a second feature/element discussed herein could be termed a first feature/element without departing from the teachings of the present invention.

An embodiment is an implementation or example of present disclosure. Reference in the specification to “an embodiment,” “one embodiment,” “some embodiments,” “one particular embodiment,” “an exemplary embodiment,” or “other embodiments,” or the like, means that a particular feature, structure, or characteristic described in connection with the embodiments is included in at least some embodiments, but not necessarily all embodiments, of the invention. The various appearances “an embodiment,” “one embodiment,” “some embodiments,” “one particular embodiment,” “an exemplary embodiment,” or “other embodiments,” or the like, are not necessarily all referring to the same embodiments.

If this specification states a component, feature, structure, or characteristic “may”, “might”, or “could” be included, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

Additionally, the method of performing the present disclosure may occur in a sequence different than those described herein. Accordingly, no sequence of the method should be read as a limitation unless explicitly stated. It is recognizable that performing some of the steps of the method in a different order could achieve a similar result.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively.

To the extent that the present disclosure has utilized the term “invention” in various titles or sections of this specification, this term was included as required by the formatting requirements of word document submissions pursuant the guidelines/requirements of the United States Patent and Trademark Office and shall not, in any manner, be considered a disavowal of any subject matter.

In the foregoing description, certain terms have been used for brevity, clearness, and understanding. No unnecessary limitations are to be implied therefrom beyond the requirement of the prior art because such terms are used for descriptive purposes and are intended to be broadly construed.

Moreover, the description and illustration of various embodiments of the disclosure are examples and the disclosure is not limited to the exact details shown or described.

We claim:

1. A fuel filter assembly comprising:
a filter element including: a substantially circular distal endcap defining a slot extending radially inward; and an elongated filter depending from the endcap, the filter having a distal end connected to the endcap, wherein at least a portion of the distal end axially aligned with the slot is completely radially inward of the slot;
a tubular housing defining an interior with a distal opening and a proximal opening;
a distal cap secured to the tubular housing to enclose the distal opening, the distal cap having a protrusion extending radially inward; and
a proximal cap removably secured to the tubular housing to enclose the proximal opening,
wherein the filter element and tubular housing are sized and configured so that:
when the filter element is inserted in the interior so that the protrusion fits within the slot, a rotational position of the filter element is set with respect to the tubular housing so that the proximal cap can be secured to the tubular housing; and when the protrusion is not within the slot, the protrusion forces the filter element to extend into the proximal opening so that the proximal cap can not be secured to the tubular housing.

2. A fuel filter assembly as recited in claim 1, wherein the elongated filter is material shaped into a plurality of pleats forming a central passage.

3. A fuel filter assembly as recited in claim 2, wherein the at least a portion of the distal end is at least one pleat being a smaller radius than other pleats.

4. A fuel filter assembly as recited in claim 1, wherein the at least a portion of the distal end has a relatively narrower circumference than a proximal end of the filter element.

5. A fuel filter assembly as recited in claim 4, wherein the filter element is cone-shaped.

6. A fuel filter assembly as recited in claim 1, wherein the protrusion depends from the distal cap and has a first axial length longer than a second axial length of the slot.

7. A fuel filter assembly as recited in claim 1, wherein the slot has sidewalls angled to act as a guide for easier insertion.

8. A fuel filter assembly comprising:
a plastic endcap having a notch on a perimeter of the endcap configured to align the fuel filter assembly with a protrusion from a housing; and
a pleated wrap coupled to the plastic endcap and including a plurality of pleats arranged to prevent deformation by the notch.

9. The fuel filter assembly of claim 8, further comprising a water separator and a center tube positioned in a central portion of the fuel filter assembly.

10. The fuel filter assembly of claim 9, wherein the center tube and the water separator are formed as a single integrated component.

11. The fuel filter assembly of claim 9, wherein the endcap further comprises eccentric protrusions along an inner circumference of an orifice to secure the water separator.

12. The fuel filter assembly of claim 8, further comprising a metallic endcap disposed opposite the plastic endcap.

13. The fuel filter assembly of claim 8, wherein at least one pleat of the plurality of pleats has a reduced height.

14. The fuel filter assembly of claim 8, wherein the plastic endcap has a first and second disc, each disc having a notch that are aligned and configured to receive the protrusion from the housing.

15. The fuel filter assembly of claim 14, wherein the first and second disc have a notch of different sizes.

16. The fuel filter assembly of claim 8, wherein the fuel filter assembly has a conical shape.

17. A fuel filter assembly comprising:
a plastic endcap having a notch on a perimeter of the endcap configured to align the fuel filter assembly with a protrusion from a housing;
and
a pleated wrap comprising a plurality of pleats arranged to prevent deformation by the notch and protrusion, wherein at least one pleat of the plurality of pleats has a reduced height.

18. The fuel filter assembly of claim 17, further comprising a water separator and a center tube positioned in a central portion of the fuel filter assembly.

19. The fuel filter assembly of claim 18, wherein the center tube and the water separator are formed as a single integrated component.

20. The fuel filter assembly of claim 18, wherein the endcap further comprises eccentric protrusions along an inner circumference of an orifice to secure the water separator.

21. The fuel filter assembly of claim 17, further comprising a metallic endcap disposed opposite the plastic endcap.

22. The fuel filter assembly of claim 17, wherein the plastic endcap has: a first and second disc, each disc having a notch that are aligned and configured to receive the protrusion from the housing; and angled sidewalls extending between the notches for guiding insertion of the fuel filter assembly.

23. A fuel filter assembly comprising:
a plastic endcap having a notch on a perimeter of the endcap configured to align the fuel filter with a protrusion from a housing; and
a pleated wrap comprising a plurality of pleats arranged to prevent deformation by the notch,
wherein the fuel filter assembly has a conical shape with the plastic endcap disposed on a smaller diameter end opposite a larger diameter end.

24. The fuel filter assembly of claim 23, further comprising a water separator positioned in a central portion of the fuel filter assembly.

25. The fuel filter assembly of claim 24, wherein the endcap further comprises eccentric protrusions along an inner circumference of an orifice to secure the water separator.

26. The fuel filter assembly of claim 23, wherein the fuel filter further comprises a metallic endcap disposed at the larger diameter end.

27. The fuel filter assembly of claim 23, wherein the notch does not contact the plurality of pleats.
